(19) United States
(12) Patent Application Publication
(10) Pub. No.: US 2011/0169858 A1
(43) Pub. Date: Jul. 14, 2011

(54) INPUT-OUTPUT APPARATUS AND INPUT-OUTPUT METHOD

(75) Inventor: Masahiro Sakaguchi, Osaka-Shi (JP)

(73) Assignee: SHARP KABUSHIKI KAISHA, Osaka (JP)

(21) Appl. No.: 12/985,656

(22) Filed: Jan. 6, 2011

(30) Foreign Application Priority Data
Jan. 8, 2010 (JP) 2010-003190

(51) Int. Cl. G06F 3/041; G09G 5/02

(52) U.S. Cl. 345/594; 345/173

(57) ABSTRACT

Upon reception of a trace inputted by handwriting, it is determined whether or not an input start position of the trace coincides with part of a trace indicated by trace information stored in a trace table or saved trace indicated by trace information stored in a saved trace table. When the input start position coincides with neither of them, sequentially received trace information is accumulated in the trace table. When the input start position coincides with either of them, a corresponding menu image is displayed, and it is determined whether, any one of processes is selected from the menu image. Then, the process selected from the menu image is executed.

### CROSS-REFERENCE TO RELATED APPLICATIONS

This Nonprovisional application claims priority under 35 U.S.C. §119(a) on Patent Application No. 2010-3190 filed in Japan on Jan. 8, 2010, the entire contents of which are hereby incorporated by reference.

### BACKGROUND

1. Technical Field

The present invention relates to an input-output apparatus and an input-output method for displaying data on a display device, receiving a handwriting trace, and allowing the received trace to be displayed on the displayed data.

2. Description of Related Art

For example, when results of studies are given, a lecture is delivered or a presentation is made, a presentation tool is used. A presentation tool used in this case is implemented by connecting a personal computer with various audiovisual devices including a projector such as a liquid crystal projector, a display device such as a large liquid crystal display, and a sound output device such as a speaker. In a presentation made using such a presentation tool, a presenter points out any position on a display screen with a pointer such as a pointing rod or a laser pointer, thereby prompting listeners to pay attention to the position to which attention is desired to be given.

Further, in a recent presentation, presentation software such as PowerPoint (registered trademark) produced by Microsoft Corporation, for example, is used, and a plurality of image files prepared in advance are displayed while being switched sequentially or randomly. Moreover, a presenter uses an input apparatus such as a mouse, a tablet or a digitizer during a presentation to add information, such as one that is additionally explained, to displayed information or to correct or delete displayed information.

Furthermore, for example, Japanese Patent Application Laid-Open No. 5-56425 discloses a system in which an addition and a correction can be made to information, shared among meeting participants, from all terminals used by the respective participants. In this system, all the meeting participants always see the same shared information; therefore, even when an addition or a correction is made to the information, shared among the meeting participants, by any one of the meeting participants, all the meeting participants can always see the latest information.

Besides, Japanese Patent Application Laid-Open No. 2007-80005 and Japanese Patent Application Laid-Open No. 2006-145643 each disclose an apparatus for superposing or overlaying, on presentation contents, an image inputted by handwriting in the course of a presentation, and for automatically erasing the superposed or overlaid image from the contents after a lapse of a predetermined period of time. With this apparatus, since information added in the course of a presentation is automatically erased after a lapse of a predetermined period of time, an operation for erasing added information is unnecessary, thus making it possible to save time and trouble of the operation performed by a presenter who makes a presentation.

### SUMMARY OF THE INVENTION

However, an object of the system disclosed in Japanese Patent Application Laid-Open No. 5-56425 is to allow information, by which an addition or correction is made to information shared among the meeting participants, to be shared among all the meeting participants, and therefore, erasure of added information is not envisaged. In other words, the system disclosed in Japanese Patent Application Laid-Open No. 5-56425 is configured to update information, by which an addition or correction is made, on an as-needed basis, but is not configured to temporarily display only information by which an addition is made.

Further, in the apparatus disclosed in each of Japanese Patent Application Laid-Open No. 2007-80005 and Japanese Patent Application Laid-Open No. 2006-145643, an image inputted by handwriting in the course of a presentation is displayed only for a preset period of time; hence, depending on the progress of a presentation, timing of erasure of an image inputted by handwriting might be too fast or slow, and the image might not be erased with timing desired by a presenter. In particular, the apparatus was unable to satisfy a presenter's desire to make a presentation in a state where display of an image inputted by handwriting is continued.

The present invention has been made in view of the above-described circumstances, and its object is to provide an input-output apparatus and an input-output method which are capable of allowing a presentation to be made without concern for a display end time of handwriting information (trace), eliminating the need for an operation necessary to erase an unnecessary trace, and reducing a user's operation burden.

In one aspect, an input-output apparatus according to the present invention includes: a data output section for outputting data to a display device to display the data thereon; a trace receiving section for receiving a handwriting trace; and a trace output section for outputting the trace, received by the trace receiving section, to the display device to display the trace on the data displayed on the display device, wherein the input-output apparatus further includes a time measurement section for measuring, upon reception of a trace by the trace receiving section, time elapsed until a subsequent trace is received, and wherein upon reception of the subsequent trace by the trace receiving section after a predetermined time has been measured by the time measurement section, the trace output section ends output of the previously received trace to the display device.

In another aspect, an input-output method according to the present invention outputs data to a display device to display the data thereon, receives a handwriting trace, and outputs the received trace to the display device to display the trace on the data displayed on the display device, wherein the input-output method includes steps of: measuring, upon reception of a trace, time elapsed until a subsequent trace is received; and ending output of the previously received trace to the display device upon reception of the subsequent trace after a predetermined time has been measured.

The input-output apparatus outputs data to the display device to display the data thereon, receives a trace inputted by handwriting, and outputs the received trace to the display device to display the trace on the data displayed on the display device. Further, upon reception of the subsequent trace after a lapse of a predetermined time since reception of one trace, the input-output apparatus ends output of the previously received trace to the display device. In other words, when a reception interval between sequentially handwriting traces is within the predetermined time, these traces may be handled as a series of traces (writing), but when the reception interval is equal to or longer than the predetermined time, these traces may be handled as different traces. Furthermore, when the subsequent trace is inputted after an interval of the predetermined time or longer, display of the previously inputted trace may be automatically ended.

In still another aspect, the input-output apparatus according to the present invention further includes: a determining section for determining, upon reception of a trace by the trace receiving section, whether or not the received trace coincides with part of the trace that has previously been received by the trace receiving section and that is being displayed on the display device; a menu output section for outputting, upon determination by the determining section that the received trace coincides with part of the trace that is being displayed, a menu image to the display device to display the menu image thereon, the menu image being outputted for selection of a process to be performed on the trace that is being displayed; a selection receiving section for receiving selection of the process; and an execution section for executing the process, the selection of which has been received by the selection receiving section.

When the received trace coincides with part of the trace that has previously been received and that is being displayed on the display device, the input-output apparatus allows the menu image, through which the process to be performed on the trace that is being displayed is selected, to be displayed on the display device. Furthermore, the input-output apparatus receives, from the menu image, the selection of the process to be performed on the trace that is being displayed, and executes the received process. Hence, a handwriting input is made on part of the trace that is already being displayed, thereby making it possible to perform various processes on the trace that has previously been inputted and that is being displayed.

In yet another aspect, in the input-output apparatus according to the present invention, the foregoing process includes a continuation process for continuing handwriting on the trace that is being displayed, and upon reception of selection of the continuation process by the selection receiving section, the execution section allows the trace receiving section to receive, as a continuation of the trace that is being displayed, a trace that is subsequently handwritten.

For example, upon selection of the continuation process for continuing handwriting on the trace that is already being displayed, the subsequently inputted trace is received as a continuation of the trace that is being displayed. Hence, even when a predetermined time or longer has elapsed since input of the trace that is being displayed, the traces may be handled as a series of traces without having to end display of the previously inputted trace. Accordingly, the user (presenter) of the input-output apparatus can handle sequentially handwriting traces as a series of traces by making his or her selection, thereby enabling an efficient presentation.

In still yet another aspect, in the input-output apparatus according to the present invention, the foregoing process includes a saving process for saving the trace that is being displayed, wherein the execution section has a storage processing section for storing the trace, which is being displayed, in a storage section upon reception of selection of the saving process by the selection receiving section, and wherein the trace output section outputs, to the display device, the trace stored in the storage section.

For example, upon selection of the saving process for saving the trace that is already being displayed, the input-output apparatus allows the trace, which is being displayed, to be stored in the storage section, and starts outputting, to the display device, the trace stored in the storage section. Hence, a trace inputted by handwriting may always be displayed. Accordingly, the presenter continues display of previously inputted information, and thus can make reference to the information also in an explanation given afterward, thereby enabling an efficient presentation.

In another aspect, the input-output apparatus according to the present invention further includes: a judging section for judging whether or not the trace that is being displayed is stored in the storage section upon determination by the determining section that the received trace coincides with part of the trace that is being displayed; an instruction receiving section for receiving an instruction for making a decision on whether the trace should be erased from the storage section upon judgment by the judging section that the trace is stored in the storage section; and an erasing section for erasing the trace from the storage section upon reception of an erasure instruction by the instruction receiving section.

In the input-output apparatus, even the trace, stored in the storage section so as to be always displayed, is erased from the storage section upon reception of an instruction for erasing this trace, which is being displayed, from the storage section. Hence, the continuation of display of even the trace, stored in the storage section so as to be always displayed, may be cancelled. Accordingly, when the trace stored in the storage section so as to be always displayed has become unnecessary, the presenter may end the display of this trace, thus making it possible to prevent viewability of data that should originally be displayed from being degraded by display of an unnecessary trace, and to enable a presentation that uses an easily viewable display screen.

In still another aspect, the input-output apparatus according to the present invention further includes a display color setting section for setting a display color different for each trace displayed on the display device, wherein the trace output section outputs, to the display device, a trace for which a display color is set by the display color setting section.

In the input-output apparatus, a different display color is set for each trace displayed on the display device. Hence, for example, when a mark, such as an underline, a box or a sign, is inputted by handwriting at a position on data that is being displayed on the display device, such as a position to which attention is desired to be given by listeners or a position on which an explanation will be given from now, each mark may be displayed with a different color. Accordingly, the presenter can prompt the listeners to give attention to any position on the display screen by using the display color of each trace during a presentation, and thus can make an efficient presentation. In particular, even when a plurality of analogous traces are intermingled on the display screen, visibility is increased by displaying each trace with a different display color, thereby facilitating determination of each trace.

In yet another aspect, the input-output apparatus according to the present invention further includes a display color setting section for changing, with passage of time, a display color of a trace displayed on the display device, wherein the trace output section outputs, to the display device, a trace for which a display color is set by the display color setting section.

In the input-output apparatus, the display color of the trace displayed on the display device is changed with the passage of time. Hence, display colors of a series of traces are changed with the passage of time, thereby making it possible to highlight a position to which attention is desired to be given by listeners, and to attract more attention of the listeners.

In still yet another aspect, the input-output apparatus according to the present invention further includes a display color setting section for changing, with passage of time, a density of a display color of a trace displayed on the display device, wherein the trace output section outputs, to the display device, a trace for which a display color is set by the display color setting section.

In the input-output apparatus, the density of the display color of the trace displayed on the display device is changed with the passage of time. Hence, densities of display colors of a series of traces are changed with the passage of time, thereby making it possible to highlight a position to which attention is desired to be given by listeners, and to attract more attention of the listeners.

In another aspect, the input-output apparatus according to the present invention further includes a display line setting section for setting a line type different for each trace displayed on the display device, wherein the trace output section outputs, to the display device, a trace for which a line type is set by the display line setting section.

In the input-output apparatus, a different line type is set for each trace displayed on the display device. Hence, for example, when a mark is inputted by handwriting at a position on data that is being displayed on the display device, such as a position to which attention is desired to be given by listeners, each mark may be displayed with a line different in type or thickness. Accordingly, the presenter can prompt the listeners to give attention to any position on the display screen by using the line different in type or thickness of each trace during a presentation, and thus can make an efficient presentation. In particular, even when a plurality of analogous traces are intermingled on the display screen, visibility is increased by displaying each trace with a line different in type or thickness, thereby facilitating determination of each trace.

In the present invention, upon input of a subsequent trace after an interval of the predetermined time or longer in a state where a trace inputted by handwriting is displayed on the display device, display of the previously inputted trace is ended, thus automatically erasing an unnecessary trace. Hence, the need for an operation necessary to erase an unnecessary trace is eliminated, thus reducing the user's operation load. Furthermore, display of an inputted trace is continued until a subsequent trace is inputted after an interval of the predetermined time or longer, and therefore, the presenter can make a presentation without concern for a display end time of the handwriting trace. Moreover, even when a background image (data that is being displayed) is filled with inputted traces, unnecessary traces will be erased; thus, the presenter can write information on data without concern for an adverse effect that degrades viewability of the data that should originally be displayed.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram illustrating a hardware configuration of a PC according to Embodiment 1;

FIG. 2A is a schematic diagram illustrating stored details of a trace table;

FIG. 2B is a schematic diagram illustrating stored details of a saved trace table;

FIG. 3 is a functional block diagram illustrating a functional configuration of the PC according to the Embodiment 1;

FIGS. 4A to 4D are schematic diagrams each illustrating an example of a trace displayed on a display section;

FIG. 5 is a flow chart illustrating a procedure of processing performed by a control section when a handwriting input is made;

FIG. 6 is a flow chart illustrating a procedure of the processing performed by the control section when the handwriting input is made;

FIG. 7 is a flow chart illustrating a procedure of trace accumulation processing;

FIG. 8 is a flow chart illustrating a procedure of trace accumulation processing;

FIG. 9 is a flow chart illustrating a procedure of processing performed by the control section when a trace is displayed; and

FIG. 10 is a flow chart illustrating a procedure of processing performed by the control section when the trace table or saved trace table is updated.

### DETAILED DESCRIPTION

Hereinafter, an input-output apparatus and a computer program according to the present invention will be described in detail with reference to the drawings illustrating embodiments thereof. Note that in each embodiment described below, description will be made on a configuration in which the computer program according to the present invention is read by an apparatus such as a known personal computer (hereinafter referred to as a “PC”) and is executed by a CPU (Central Processing Unit) or the like of the PC, thus implementing the input-output apparatus according to the present invention. However, the input-output apparatus according to the present invention may be implemented by using a special-purpose apparatus instead of using a general-purpose PC.

Further, the input-output apparatus according to the present invention is not limited to a PC, but may be applicable to, for example, an apparatus including a function of allowing an image to be displayed on a display section, and a function of a device such as a touch panel or a pen tablet through which an operation can be intuitively performed on the image displayed on the display section. For example, the input-output apparatus according to the present invention may be applied to a tablet type computer, an electronic blackboard, a digital still camera, a digital video camera, a portable phone, a PHS (Personal Handy-phone System), a PDA (Personal Digital Assistant), a hand-held game machine, etc.

### Embodiment 1

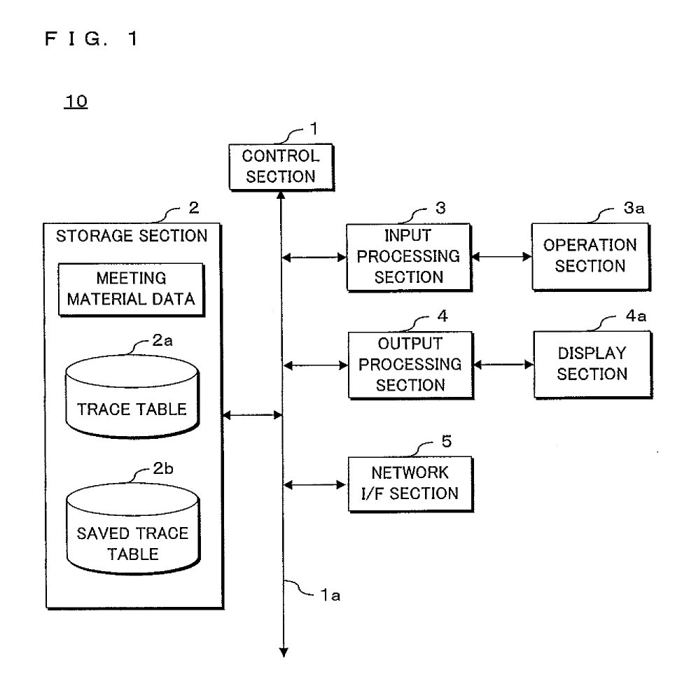

Hereinafter, a PC according to Embodiment 1 will be described. FIG. 1 is a block diagram illustrating a hardware configuration of the PC according to Embodiment 1. The PC 10 according to Embodiment 1 is a known personal computer, for example, and includes a control section 1, a storage section 2, an input processing section 3, an output processing section 4, and a network interface section (hereinafter referred to as a “network I/F section”) 5. These hardware sections are connected to each other via a bus 1a.

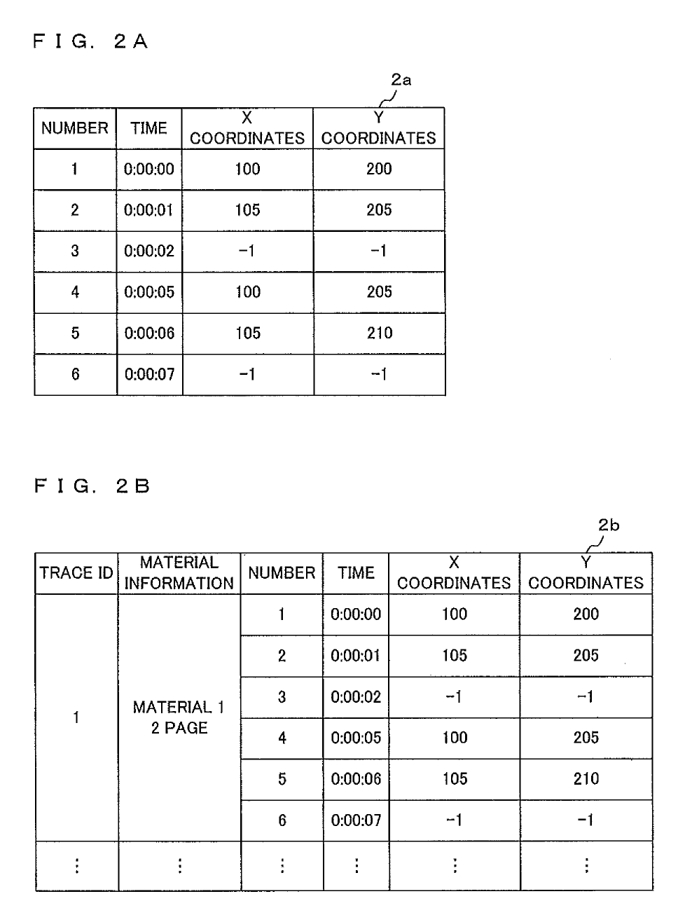

The control section 1 is a CPU, an MPU (Micro Processor Unit) or the like. The control section 1 controls each of the foregoing hardware sections, and appropriately executes control programs stored in the storage section 2. The storage section 2 is an EEPROM (Electrically Erasable and Programmable ROM), a flash ROM, a HDD (Hard Disk Drive) or the like. The storage section 2 stores various control programs necessary to operate the PC 10 as the input-output apparatus according to the present invention, various pieces of data generated at the time of execution of the control programs by the control section 1, etc. Furthermore, the storage section 2 stores document data created in advance by using the PC 10 or other PC, meeting material data such as image data, a trace table 2a such as one illustrated in FIG. 2A, a saved trace table 2b such as one illustrated in FIG. 2B, etc. Note that detailed structures of the trace table 2a and saved trace table 2b will be described later.

The input processing section 3 is connected to an operation section 3a, and acquires various pieces of information inputted by a user via the operation section 3a. The input processing section 3 sends, to the control section 1, various pieces of information inputted via the operation section 3a, and the control section 1 executes processing in accordance with the information acquired from the input processing section 3. The operation section 3a is a device such as a mouse, a keyboard, a tablet or a digitizer, for example, and includes various buttons necessary for the user to operate the PC 10. In particular, the operation section 3a according to Embodiment 1 includes a device through which an intuitive handwriting input operation can be performed on an image displayed on a display section 4a.

The output processing section (data output section) 4 is connected to the display section 4a, and outputs, to the display section 4a, a video signal in accordance with an instruction provided from the control section 1, thereby allowing the video signal to be displayed on the display section 4a. Further, in accordance with an instruction provided from the control section 1, the output processing section 4 outputs, to the display section 4a, information such as information on an operating status of the PC 10, information inputted via the operation section 3a, and information notification of which should be provided to the user. The display section 4a is a display device such as an LCD (Liquid Crystal Display), a CRT (Cathode Ray Tube) or a PDP (Plasma Display Panel), for example. Note that when a presentation is made to a large number of listeners with the use of the PC 10, the PC 10 is used with a large-screen display device connected to the output processing section 4.

Moreover, when a touch panel is used as the operation section 3a and the display section 4a, a more intuitive operation is allowed to be performed on an image displayed on the display section 4a.

It is envisaged that the PC 10 according to Embodiment 1 may be utilized for a presentation made to listeners in the same room with the use of meeting material displayed on the display section 4a, and therefore, a microphone for collecting sounds uttered by a presenter does not necessarily have to be connected to the PC 10. However, for example, when a plurality of the PCs 10 are connected via a network so as to be used for a teleconference, a plurality of the PCs 10 are each placed at a distant location. Accordingly, in that case, microphones for collecting sounds uttered by users of the PCs 10 and speakers have to be connected to the PCs 10, and sound information acquired by each microphone have to be transmitted and received between the PCs 10. Furthermore, in addition to microphones, cameras for taking videos of faces of the users of the respective PCs 10 may be connected to the PC 10s, and video information taken by each camera may be transmitted and received between the PCs 10.

The network I/F section 5 is an interface for making a connection to an IP (Internet Protocol) network (not illustrated) such as a LAN (Local Area Network) or a WAN (Wide Area Network). The network I/F section 5 transmits and receives information to and from various devices connected via the IP network.

FIG. 2A illustrates stored details of the trace table 2a, and FIG. 2B illustrates stored details of the saved trace table 2b. The trace table 2a stores trace information indicative of a trace inputted by handwriting by the user (presenter) of the PC 10 via the operation section 3a. As illustrated in FIG. 2A, trace information includes information such as numbers, times, X coordinates, and Y coordinates. Further, the trace table 2a stores only trace information on a series of traces.

Note that when a subsequent handwriting input does not start until a lapse of a preset time (trace determination time) since the end of a handwriting input made by the presenter (i.e., since separation of a finger of the presenter or a touch pen from a display screen when, for example, a touch panel is used), previously inputted traces are handled as a series of traces. In other words, when a subsequent handwriting input is started before a lapse of the preset time since the end of a handwriting input made by the presenter, resulting traces are handled as a series of traces. The trace determination time for determining a series of traces is several tens of milliseconds or several seconds, for example, freely set by the user of the PC 10, and stored in the storage section 2.

The numbers provided in the trace table 2a are numbers by which respective points constituting a handwriting trace are identified and to which 1, 2, 3 . . . are allocated in the order in which they are stored in the trace table 2a, for example. The times provided in the trace table 2a indicate times elapsed from the start of a handwriting input, with the starting time of a series of handwriting inputs set to 0 min 00 sec 00 msec. Note that in the trace table 2a illustrated in FIG. 2A, the trace information (coordinates) of the respective points constituting a series of traces are accumulated every millisecond. However, accumulation timing of trace information of respective points (trace accumulation time) is not limited to one millisecond, but may be freely changed by the user of the PC 10. The trace accumulation time, to which reference is made when trace information of respective points is accumulated, is set in advance by the user of the PC 10 and stored in the storage section 2.

The X and Y coordinates provided in the trace table 2a are coordinate values of the respective points constituting a series of traces. For example, the X and Y coordinates provided in the trace table 2a are coordinate values when the point located at the upper left of a displayable region of the display section 4a is defined as a reference point (0, 0), a rightward direction with respect to the reference point (0, 0) is defined as an X coordinate axis, and a downward direction with respect to the reference point (0, 0) is defined as a Y coordinate axis. Note that the reference point (0, 0) may be defined as the point located at the upper right, lower left or lower right of the displayable region of the display section 4a. Also note that when a handwriting input has temporarily been ended by the presenter, i.e., when the presenter has reached a breakpoint for each trace inputted by handwriting, at the time of storage of the X and Y coordinates in the trace table 2a, −1 is stored for each of the X and Y coordinates.

Each piece of information stored in the trace table 2a is stored in the trace table 2a by the control section 1 every time the trace accumulation time elapses when a handwriting input is started by the presenter via the operation section 3a.

The saved trace table 2b stores trace information of the traces (saved traces), for which permanent display is set, among the traces that have already been inputted by handwriting by the presenter via the operation section 3a. As illustrated in FIG. 2B, the saved trace table 2b stores trace information such as trace IDs, material information, numbers, times, X coordinates, and Y coordinates. When permanent display is set for the traces whose trace information is stored in the trace table 2a, the numbers, times, X coordinates and Y coordinates, which have been stored in the trace table 2a at that time, will be stored in fields of the numbers, times, X coordinates and Y coordinates in the saved trace table 2b just the way they are.

The trace IDs provided in the saved trace table 2b are information by which the trace information stored in the saved trace table 2b is identified and to which 1, 2, 3 . . . are allocated in the order in which they are stored in the saved trace table 2b, for example. The material information provided in the saved trace table 2b is information indicative of meeting material to which the trace indicated by the trace information is added. For example, the material information is information such as file name, folder name and page number of meeting material data.

Each piece of information stored in the saved trace table 2b is stored in the saved trace table 2b by the control section 1 when the presenter sets permanent display for the trace whose trace information is stored in the trace table 2a.

Each piece of information stored in the storage section 2 does not necessarily have to be stored in advance in the storage section 2. When the PC 10 includes a driver (not illustrated) capable of reading data stored in an external memory (not illustrated), various pieces of information stored in the external memory may be read by the driver and stored in the storage section 2. Alternatively, various pieces of information may be downloaded from an external device via the IP network and stored in the storage section 2.

The PC 10 configured as described above allows meeting material data, stored in the storage section 2, to be displayed on the display section 4a in accordance with an instruction provided from the user (presenter) who makes a presentation by using the PC 10. Further, the PC 10 allows information, inputted by handwriting by the presenter via the operation section 3a, to be displayed so as to be superimposed on the meeting material displayed on the display section 4a. Thus, the presenter can easily point out a position on a display screen, to which attention is desired to be given by listeners, and the listeners can easily grasp which position of the meeting material is being explained by the presenter.

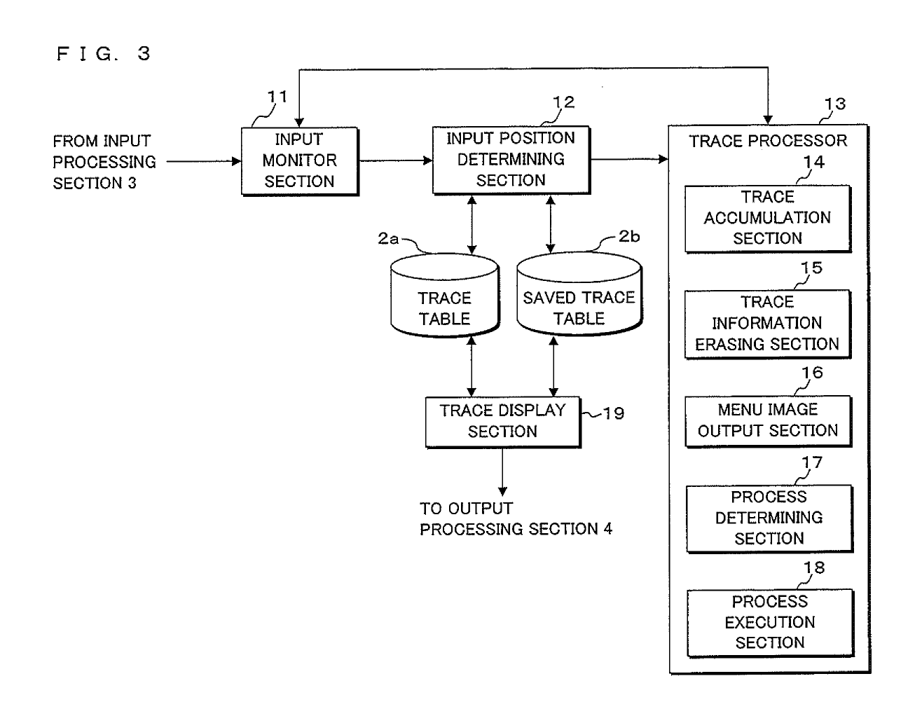

Hereinafter, functions implemented by execution of the control program, stored in the storage section 2, by the control section 1 in the PC 10 according to Embodiment 1 will be described. FIG. 3 is a functional block diagram illustrating a functional configuration of the PC 10 according to the Embodiment 1. The PC 10 according to Embodiment 1 executes the control program, stored in the storage section 2, by the control section 1, thereby implementing functions of components such as: an input monitor section 11; an input position determining section 12; a trace processor 13; and a trace display section 19. Moreover, the trace processor 13 has functions of: a trace accumulation section 14; a trace information erasing section 15; a menu image output section 16; a process determining section 17; and a process execution section 18.

The presenter who uses the PC 10 inputs information, which is to be added on the meeting material displayed on the display section 4a, by handwriting via the operation section 3a while allowing meeting material data used for a presentation to be displayed on the display section 4a.

The input monitor section (trace receiving section) 11 receives, via the input processing section 3, a trace inputted by handwriting by the presenter with the use of the operation section 3a. Specifically, when a handwriting input is started for the meeting material, displayed on the display section 4a, by the presenter via the operation section 3a, the input monitor section 11 acquires coordinate values of respective points indicative of a handwriting trace at predetermined trace accumulation time intervals. Note that the coordinate values of the respective points indicative of the trace are represented by coordinate values determined using the predetermined reference point (0, 0) as the reference. Further, when a handwriting input has been ended by the presenter with the timing of acquisition of coordinate values of respective points, the input monitor section 11 acquires −1 for each of the X and Y coordinates in this case.

The input monitor section 11 has: a trace accumulation tinier for counting the preset trace accumulation time and a trace determination timer for counting the preset trace determination time. Furthermore, when a handwriting input is started by the presenter, the input monitor section 11 resets the trace accumulation timer to 0 min 00 sec 00 msec, and starts counting time at the trace accumulation time intervals (e.g., at intervals of one millisecond). Whenever necessary, the input monitor section 11 sends, to the input position determining section 12 and the trace processor 13, the times indicated by the trace accumulation timer at the trace accumulation time intervals and the coordinate values of each point acquired at each time point.

In addition, when the handwriting input made by the presenter is ended, i.e., when coordinate values (−1, −1) are acquired as trace coordinate values, the input monitor section (time measurement section) 11 resets the trace determination tinier and starts measurement of time until the start of a subsequent handwriting input. Upon start of the subsequent handwriting input, the input monitor section 11 determines whether or not the trace determination time has elapsed based on a time measurement result obtained by the trace determination tinier. When the subsequent handwritten input has been started before the lapse of the trace determination time, the input monitor section 11 receives the subsequently inputted trace as a continuation of the previously inputted trace. On the other hand, when the subsequent handwriting input has been started after the lapse of the trace determination time, the input monitor section 11 determines the previously inputted trace and the subsequently inputted trace as different traces, resets the trace accumulation tinier to 0 min. 00 sec 00 msec, and starts acquisition of coordinate values of each point of the subsequently inputted trace.

The input position determining section 12 acquires the times indicated by the trace accumulation timer of the input monitor section 11, and the coordinate values of each point acquired at each time point. Upon acquisition of the coordinate values corresponding to 0 min 00 sec 00 msec from the input monitor section 11, the input position determining section (including a determining section and a judging section) 12 determines whether or not the point indicated by the acquired coordinate values coincides with part of the trace whose trace information is stored in the trace table 2a or the saved trace whose trace information is stored in the saved trace table 2b. Specifically, the input position determining section 12 determines whether or not the coordinate values identical to the acquired coordinate values are stored in the trace table 2a or the saved trace table 2b. The input position determining section 12 notifies the trace processor 13 of one of a determination result indicating that the point indicated by the acquired coordinate values coincides with part of the trace whose trace information is stored in the trace table 2a; a determination result indicating that the point indicated by the acquired coordinate values coincides with part of the saved trace whose trace information is stored in the saved trace table 2b; and a determination result indicating that the point indicated by the acquired coordinate values coincides with neither of them.

When the trace processor 13 is notified of the determination result indicating that the point indicated by the acquired coordinate values coincides with neither part of the trace whose trace information is stored in the trace table 2a nor part of the saved trace whose trace information is stored in the saved trace table 2b, the trace processor 13 accumulates the times and coordinate values (X and Y coordinates), sequentially acquired from the input monitor section 11, in the trace table 2a by using the trace accumulation section 14. Specifically, the trace accumulation section 14 allocates numbers to the times and coordinate values sequentially acquired from the input monitor section 11, and stores, in the trace table 2a, the allocated numbers and the times and coordinate values that are sequentially acquired.

Note that in this case, when trace information has already been stored in the trace table 2a, the trace processor 13 resets the trace table 2a by erasing, using the trace information erasing section 15, the trace information stored in the trace table 2a, and then starts accumulation processing using the trace accumulation section 14. Thus, upon input of the coordinate values corresponding to 0 min 00 sec 00 msec from the input monitor section 11, i.e., upon start of new trace handwriting via the operation section 3a, the trace information of the previously inputted trace can be erased from the trace table 2a.

When the trace processor 13 is notified of the determination result indicating that the point indicated by the acquired coordinate values coincides with either part of the trace whose trace information is stored in the trace table 2a or part of the saved trace whose trace information is stored in the saved trace table 2b, the trace processor 13 allows a corresponding menu image to be displayed on the display section 4a by using the menu image output section (menu output section) 16. Specifically, when the trace processor 13 is notified of the determination result indicating that the point indicated by the acquired coordinate values coincides with part of the trace whose trace information is stored in the trace table 2a, the menu image output section 16 outputs, to the output processing section 4, the menu image for selecting a process to be performed on the trace whose trace information is stored in the trace table 2a. On the other hand, when the trace processor 13 is notified of the determination result indicating that the point indicated by the acquired coordinate values coincides with part of the saved trace whose trace information is stored in the saved trace table 2b, the menu image output section 16 outputs, to the output processing section 4, the menu image for selecting a process to be performed on the saved trace whose trace information is stored in the saved trace table 2b. The output processing section 4 outputs, to the display section 4a, the menu image acquired from the menu image output section 16, thereby allowing the menu image to be displayed on the meeting material displayed on the display section 4a.

Upon display of the menu image on the display section 4a, the input monitor section 11 sends, to the trace processor 13, only coordinate values of respective points indicative of a trace that is inputted by handwriting by the presenter via the operation section 3a from then on. Then, based on the coordinate values acquired from the input monitor section 11 and by using the process determining section (selection receiving section) 17, the trace processor 13 determines which process displayed on the menu image is selected. Specifically, the process determining section 17 compares a display region of each process displayed on the menu image with the coordinate values acquired from the input monitor section 11, and determines which process has, in its display region, the point indicated by the coordinate values acquired from the input monitor section 11. Then, the process determining section 17 receives, as the process to be executed, the process that has, in its display region, the point indicated by the coordinate values acquired from the input monitor section 11.

In Embodiment 1, processes performed on the trace whose trace information is stored in the trace table 2a include a saving process for saving the trace and a continuation process for continuing handwriting on the trace. Besides, processes performed on the saved trace whose trace information is stored in the saved trace table 2b include an erasure process for canceling saving of the saved trace and erasing the saved trace.

Upon reception of any one of the processes from the menu image, the process determining section 17 notifies the process execution section 18 of the received process, and the process execution section (execution section) 18 executes the process, notification of which has been provided from the process determining section 17.

For example, when the process determining section 17 has received the continuation process for the trace whose trace information is stored in the trace table 2a, the process execution section 18 allows trace information of a subsequently handwriting trace to be accumulated in the trace table 2a as a continuation of the trace information accumulated up to that time in the trace table 2a. Specifically, the process execution section 18 reads the latest time from the times stored in the trace table 2a, sets it to the trace accumulation timer of the input monitor section 11, and starts acquisition of coordinate values by the input monitor section 11. The input monitor section 11 starts sending, to the trace processor 13, times indicated by the trace accumulation timer and coordinate values of each point acquired at each time point.

When the trace table 2a is in the state illustrated in FIG. 2A, the process execution section 18 reads 0 min 00 sec 07 msec, sets it to the trace accumulation timer, and starts acquisition of coordinate values. Thus, for example, even if a long time (trace determination time) has elapsed since accumulation of trace information of a previously handwriting trace in the trace table 2a, a subsequently handwriting trace can be handled as a continuation of the previously handwriting trace.

Further, when the process determining section 17 has received the saving process for the trace whose trace information is stored in the trace table 2a, the process execution section (storage processing section) 18 allows the trace information, stored in the trace table 2a, to be stored in the saved trace table 2b in such a manner that the trace information is associated with trace ID and material information. Note that when the trace information is copied from the trace table 2a to the saved trace table 2b by the process execution section 18, the trace information erasing section 15 erases the trace information from the trace table 2a to reset the trace table 2a.

Moreover, when the process determining section (instruction receiving section) 17 has received the erasure process for the saved trace whose trace information is stored in the saved trace table 2b, the process execution section 18 allows the trace information erasing section (erasing section) 15 to erase, from the saved trace table 2b, the trace information of the saved trace that should be erased.

Based on the coordinate values stored in the trace table 2a and the coordinate values stored in the saved trace table 2b, the trace display section 19 generates trace information of a trace that should be displayed on meeting material displayed on the display section 4a, and outputs the generated trace information to the output processing section 4. Specifically, the trace display section 19 plots a point indicated by the respective coordinate values stored in the trace table 2a, and adds a straight line between this point and the immediately preceding plotted point as long as the immediately preceding coordinate values are not (−1, −1). Similarly, the trace display section 19 plots a point indicated by the respective coordinate values stored in the saved trace table 2b, and adds a straight line between this point and the immediately preceding plotted point as long as the immediately preceding coordinate values are not (−1, −1). Thus, trace information for allowing a series of traces, handwritten by the presenter and stored in the trace table 2a or the saved trace table 2b, to be displayed can be generated.

The output processing section (trace output section) 4 outputs, to the display section 4a, the trace information acquired from the trace display section 19, and allows the trace, generated based on the outputted trace information, to be displayed on the meeting material displayed on the display section 4a. Thus, even when the trace information stored in the trace table 2a and the saved trace table 2b is appropriately changed by the various processes performed by the trace processor 13, the latest trace and saved trace can each be displayed. Note that in the PC 10 according to Embodiment 1, meeting material data displayed on the display section 4a and trace information displayed on meeting material are handled as different layers, and therefore, only the layer of trace information that is appropriately changed is updated, thereby allowing trace information appropriately inputted by the presenter to be displayed in a suitable manner.

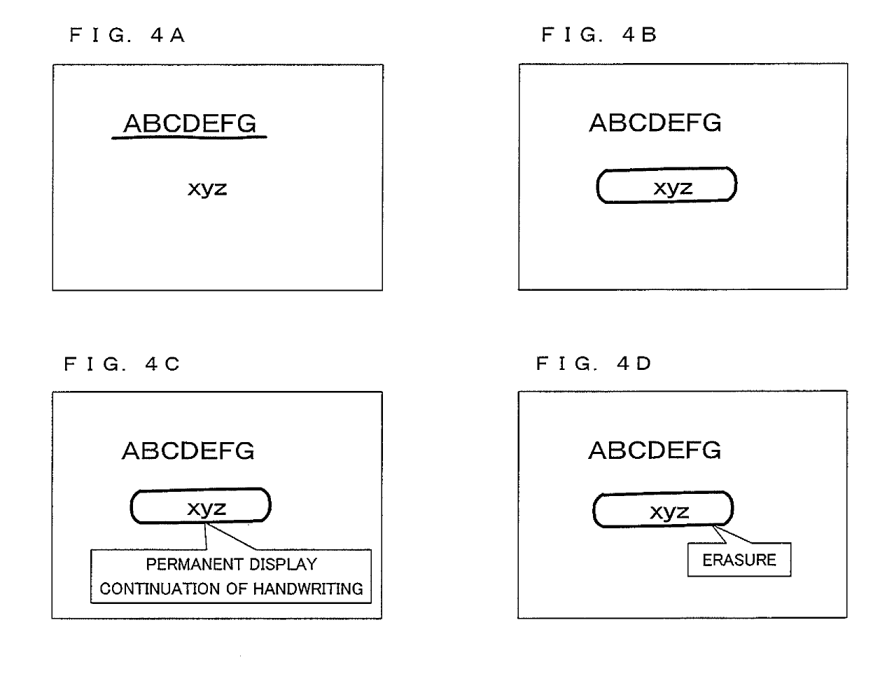

FIGS. 4A to 4D are schematic diagrams each illustrating an example of a trace displayed on the display section 4a. FIG. 4A illustrates a state in which a single underline is handwritten for “ABCDEFG” in meeting material that is being displayed on the display section 4a. On a display screen illustrated in FIG. 4B, when a box surrounding “xyz” is handwritten after a lapse of a predetermined time (trace determination time) since the handwriting of the underline, the control section 1 ends the display of the underline added to “ABCDEFG” and allows only the box to be displayed as illustrated in FIG. 4B.

Specifically, the control section 1 deletes, from the trace table 2a, the trace information indicative of the underline added to “ABCDEFG”, and accumulates, in the trace table 2a, the trace information indicative of the box added to “xyz”. Note that when a box is handwritten before a lapse of the trace determination time since the handwriting of the underline on the display screen illustrated in FIG. 4A, the control section 1 handles the underline and the box as a series of traces, and accumulates, in the trace table 2a, the trace information indicative of the box as a continuation of the trace information indicative of the underline.

Further, when an operation (handwriting) is performed on part of the box via the operation section 3a on the display screen illustrated in FIG. 4B in a state where the trace information of the box surrounding “xyz” is stored in the trace table 2a, the control section 1 allows a menu image such as one illustrated in FIG. 4C to be displayed. On the other hand, when an operation (handwriting) is performed on part of the box via the operation section 3a on the display screen illustrated in FIG. 4B in a state where the trace information of the box surrounding “xyz” is stored in the saved trace table 2b, the control section 1 allows a menu image such as one illustrated in FIG. 4D to be displayed.

Moreover, when any one of the processes (specifically, permanent display, continuation of handwriting, or erasure) in the menu image is selected on the display screen illustrated in FIG. 4C or 4D, the control section 1 executes the selected process.

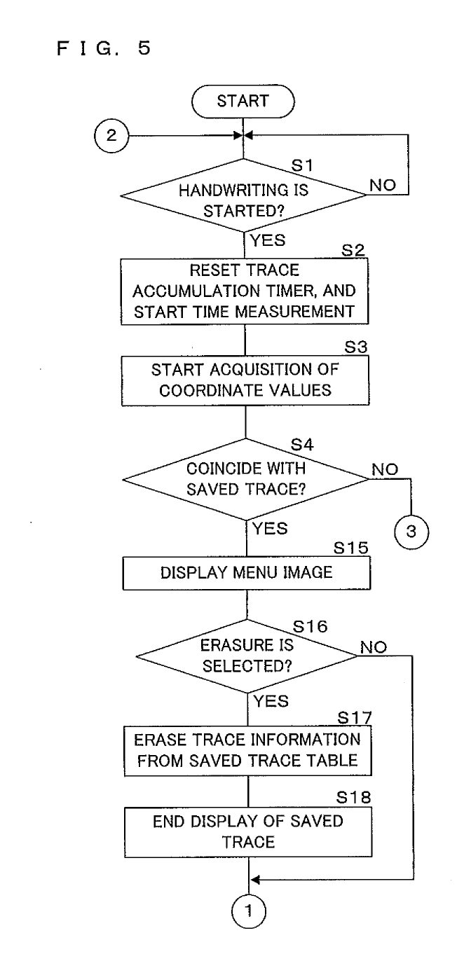

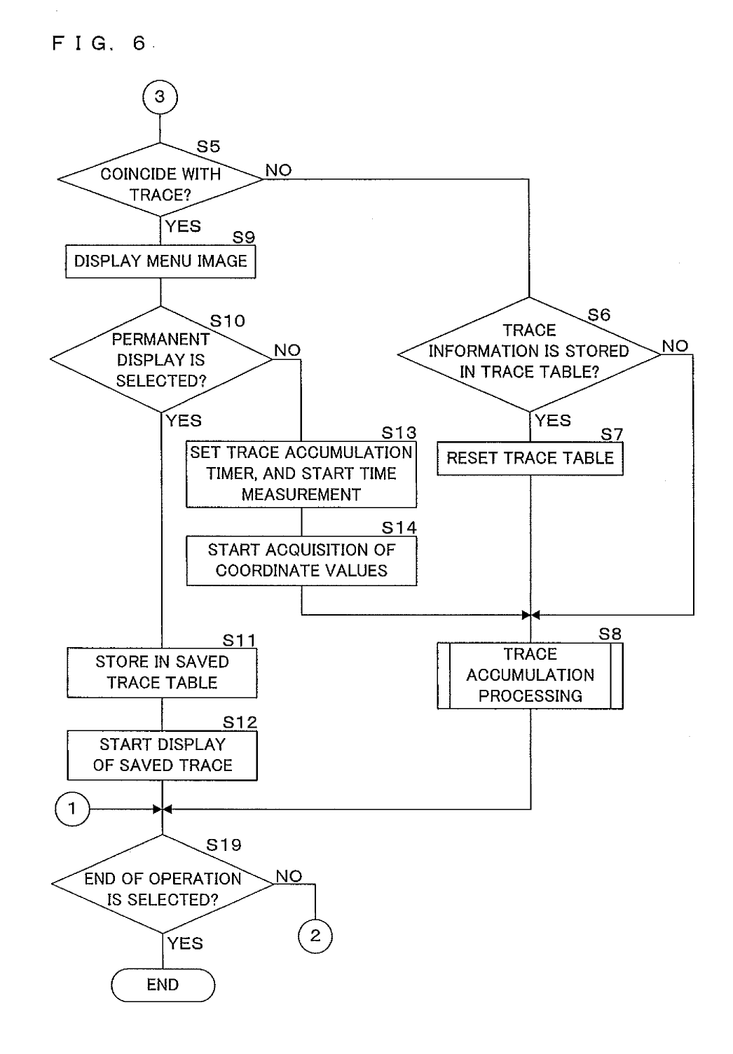

Hereinafter, processing performed by the control section 1 when a handwriting input is made via the operation section 3a in the PC 10 according to Embodiment 1 will be described based on flow charts. FIGS. 5 and 6 are flow charts illustrating a procedure of the processing performed by the control section 1 when a handwriting input is made. The following processing is executed by the control section 1 in accordance with the control program stored in the storage section 2 of the PC 10.

The control section 1 of the PC 10 determines whether or not a handwriting input on meeting material that is being displayed is started by the presenter via the operation section 3a while allowing meeting material data to be displayed on the display section 4a in accordance with an instruction provided from the presenter (user) via the operation section 3a (S1). Upon determination that no handwriting input is started by the presenter (S1: NO), the control section 1 enters a standby mode until a handwriting input is started while allowing the meeting material data to be displayed on the display section 4a.

Upon determination that a handwriting input is started by the presenter (S1: YES), the control section 1 resets the trace accumulation tinier to 0 min 00 sec 00 msec, and starts measurement of the trace accumulation time (S2). Then, based on information acquired from the input processing section 3, the control section 1 starts acquisition of coordinate values of respective points indicative of a trace handwritten by the presenter (S3). Note that the control section 1 according to Embodiment 1 acquires coordinate values of respective points at intervals of one millisecond (at the predetermined trace accumulation time intervals) counted by the trace accumulation tinier. Furthermore, when the handwriting input has been ended by the presenter with the timing of acquisition of coordinate values of respective points, the control section 1 sets each of X and Y coordinates to −1 in this case.

The control section 1 determines, based on coordinate values acquired sequentially, whether or not a point, indicated by the coordinate values corresponding to 0 min 00 sec 00 msec given by the trace accumulation timer, coincides with part of a saved trace whose trace information is stored in the saved trace table 2b (S4). Upon determination that the point does not coincide with part of the saved trace (S4: NO), the control section 1 determines whether or not the point, indicated by the coordinate values corresponding to 0 min 00 sec 00 msec given by the trace accumulation timer, coincides with part of a trace whose trace information is stored in the trace table 2a (S5).

Upon determination that the point does not coincide with part of the trace whose trace information is stored in the trace table 2a (S5: NO), the control section 1 determines whether or not trace information is stored in the trace table 2a (S6). Upon determination that trace information is stored in the trace table 2a (S6: YES), the control section 1 erases the trace information stored in the trace table 2a to reset the trace table 2a (S7), and executes after-mentioned trace accumulation processing (S8). Hence, when trace information of a previously inputted trace has been stored in the trace table 2a at the start of handwriting of a new trace via the operation section 3a, this trace information can be erased from the trace table 2a.

Upon determination that no trace information is stored in the trace table 2a (S6: NO), the control section 1 skips the process of Step S7, and executes the after-mentioned trace accumulation processing (S8). After execution of the trace accumulation processing, the control section 1 moves the procedure to Step S19.

On the other hand, upon determination that the point coincides with part of the trace whose trace information is stored in the trace table 2a (S5: YES), the control section 1 outputs, to the display section 4a, a menu image prepared in advance and allows the menu image to be displayed thereon (S9). In this case, as illustrated in FIG. 4C, the menu image for selecting a process, which is to be performed on the trace whose trace information is stored in the trace table 2a, is displayed on the meeting material.

The control section 1 determines whether or not permanent display (saving process) is selected for the trace, whose trace information is stored in the trace table 2a, from the menu image displayed on the display section 4a (S10). Specifically, the control section 1 compares a display region of each process displayed on the menu image with coordinate values indicative of a handwriting trace, thereby determining whether or not the handwriting trace is located within the display region of permanent display. Upon determination that permanent display is selected (S10: YES), the control section 1 associates the trace information stored in the trace table 2a with trace ID and material information, and allows the resulting trace information to be stored in the saved trace table 2b (sib). Note that in this case, the control section 1 erases the trace information stored in the trace table 2a to reset the trace table 2a.

Then, the control section 1 starts outputting, to the display section 4a, the trace information (coordinate values) stored in the saved trace table 2b, and starts displaying, on the display section 4a, the saved trace whose trace information is stored in the saved trace table 2b (S12). Thus, the trace (saved trace) for which permanent display is set by the presenter is always displayed on the meeting material. Therefore, also in an explanation given afterward, the presenter can make reference to the trace for which permanent display is set, thereby enabling an efficient presentation. Then, the control section 1 moves the procedure to Step S19.

Upon determination that permanent display is not selected (S10: NO), i.e., upon selection of the handwriting continuation process from the menu image illustrated in FIG. 4C, the control section 1 reads the latest time from times stored in the trace table 2a, sets it to the trace accumulation timer, and starts measurement of the trace accumulation time (S13). Furthermore, based on information acquired from the input processing section 3, the control section 1 starts acquisition of coordinate values of respective points indicative of a trace subsequently handwritten by the presenter (S14). Then, the control section 1 executes the after-mentioned trace accumulation processing (S8), and after execution of the trace accumulation processing, the control section 1 moves the procedure to Step S19. Thus, as a continuation of the trace information accumulated up to that time in the trace table 2a, the trace information of the subsequently handwriting trace can be accumulated in the trace table 2a.

Upon determination that the point coincides with part of the saved trace (S4: YES), the control section 1 outputs, to the display section 4a, the menu image prepared in advance and allows the menu image to be displayed thereon (S15). In this case, as illustrated in FIG. 4D, the menu image for selecting a process, which is to be performed on the saved trace whose trace information is stored in the saved trace table 2b, is displayed on the meeting material.

The control section 1 determines whether or not erasure is selected for the saved trace, whose trace information is stored in the saved trace table 2b, from the menu image displayed on the display section 4a (S16). Upon determination that erasure is selected (S16: YES), the control section 1 erases, from the saved trace table 2b, the trace information of the saved trace that is determined as being partially coincident with the point in Step S4 (S17).

Then, the control section 1 ends the output of the trace information (coordinate values), erased from the saved trace table 2b, to the display section 4a, thereby ending the display of this saved trace on the display section 4a (S18). Thus, even the trace, for which permanent display has temporarily been set, can be erased from the meeting material upon selection of erasure by the presenter, and therefore, display of each trace can be ended at a time point when the trace becomes unnecessary, thereby enabling an efficient presentation.

Upon determination that erasure is not selected (S16: NO), the control section 1 skips the processes of Steps S17 and S18, and determines whether or not the end of operation of the PC 10 is selected (S19). Upon determination that the end of operation of the PC 10 is not selected (S19: NO), the control section 1 returns the procedure to Step S1 to repeat the foregoing processes; on the other hand, upon determination that the end of operation of the PC 10 is selected (S19: YES), the control section 1 ends the operation of the PC 10.

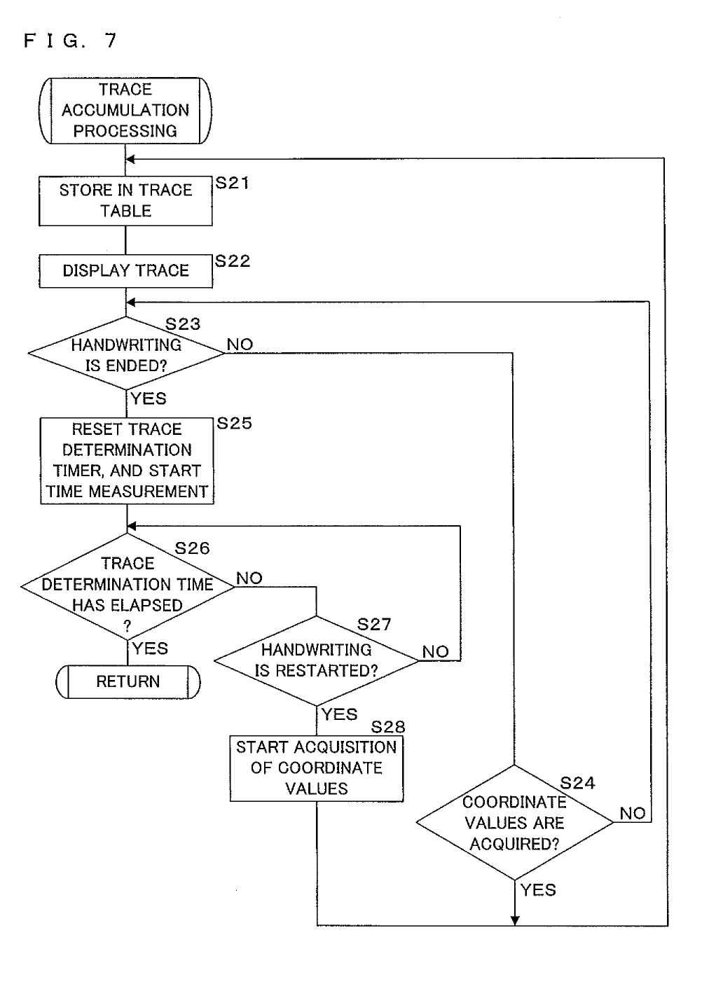

Next, the trace accumulation processing (corresponding to Step S8 in FIG. 6) performed by the control section 1 in the PC 10 according to Embodiment 1 will be described with reference to a flow chart. FIG. 7 is a flow chart illustrating a procedure of the trace accumulation processing.

When a handwriting input is started, the control section 1 allocates a number to: the time indicated by the trace accumulation timer sequentially updated by the time measurement process started in Step S2 in FIG. 5; and the coordinate values (coordinate values of a trace point) sequentially acquired by the acquisition process started in Step S3, and allows the resulting information to be stored in the trace table 2a (S21). Then, the control section 1 outputs, to the display section 4a, the trace information (coordinate values) stored in the trace table 2a, and allows the trace indicated by this trace information to be displayed on the meeting material (S22). Thus, the trace handwritten by the presenter on an as needed basis is displayed on the meeting material in such a manner that the trace is updated whenever necessary, and therefore, the presenter can make a presentation while making reference to the information added on the meeting material.

The control section 1 determines whether or not the handwriting input started in Step S1 in FIG. 5 is ended (S23). Specifically, based on information acquired from the input processing section 3, the control section 1 determines whether or not coordinate values (−1, −1) are acquired as the coordinate values of the trace handwritten by the presenter, and upon determination that the coordinate values (−1, −1) are acquired, the control section 1 determines that the handwriting input is ended.

Upon determination that the handwriting input is not ended (S23: NO), the control section 1 determines whether or not coordinate values, obtained at the predetermined time intervals (at the trace accumulation time intervals), are acquired (S24). Specifically, based on the times indicated by the trace accumulation timer, the control section 1 acquires, at the trace accumulation time intervals, coordinate values of a trace, handwritten by the presenter, from the information acquired from the input processing section 3, and determines whether or not subsequent coordinate values are acquired.

Upon determination that the subsequent coordinate values are not acquired (S24: NO), the control section 1 returns the procedure to Step S23, and repeats the processes of Steps S23 and S24 until the handwriting input is ended by the presenter or the subsequent coordinate values are acquired. Upon determination that the subsequent coordinate values are acquired (S24: YES), the control section 1 returns the procedure to Step S21, allocates a number to the time indicated by the trace accumulation timer and the subsequently acquired coordinate values, and allows the resulting information to be stored in the trace table 2a (S21). Then, the control section 1 repeats the process of S22 and the subsequent processes.

Upon determination that the handwriting input by the presenter is ended (S23: YES), the control section 1 resets the trace determination timer to 0 min 00 sec 00 msec, and starts measurement of the preset trace determination time (S25). The control section 1 determines whether or not the trace determination time has elapsed based on the time indicated by the trace determination timer (S26), and upon determination that the trace determination time has elapsed (S26: YES), the procedure is returned to that illustrated in FIGS. 5 and 6. Thus, upon lapse of the trace determination time since the end of the handwriting input by the presenter, traces inputted previously and subsequently can be handled as different traces.

Upon determination that the trace determination time has not elapsed (S26: NO), the control section 1 determines whether or not the handwriting input by the presenter is restarted based on the information acquired from the input processing section 3 (S27). Upon determination that the handwriting input is not restarted (S27: NO), the control section 1 returns the procedure to Step S26, and repeats the processes of Steps S26 and S27 until the trace determination time elapses or the handwriting input is restarted.

Upon determination that the handwriting input by the presenter is restarted (S27: YES), the control section 1 starts acquisition of coordinate values of respective points indicative of a trace, handwritten by the presenter, based on the information acquired from the input processing section 3 (S28). Then, the control section 1 returns the procedure to Step S21, allocates a number to the time indicated by the trace accumulation timer and the acquired coordinate values, and allows the resulting information to be stored in the trace table 2a (S21). Thereafter, the control section 1 repeats the process of Step S22 and the subsequent processes.

As a result of the above-described processing, upon lapse of the predetermined time (trace determination time) since the end of handwriting by the presenter, the PC 10 according to Embodiment 1 can handle a subsequently handwriting trace as a trace different from a previously handwriting trace. Further, upon start of a new trace input after lapse of the trace determination time, the PC 10 according to Embodiment 1 can automatically end the display of the previously inputted trace on the display section 4a. Hence, an unnecessary trace is automatically erased from the display screen without having to perform an operation for erasing the unnecessary trace, thus reducing the operation load of the user (presenter) of the PC 10.

Furthermore, the PC 10 according to Embodiment 1 is capable of continuing the display of the handwriting trace on the display screen until a subsequent trace is handwritten after lapse of the trace determination time. Hence, the presenter can make a presentation without concern for a display end time of a handwriting trace, and thus can concentrate on the presentation. Moreover, even when the trace determination time has elapsed since the end of handwriting by the presenter, the PC 10 according to Embodiment 1 can handle a subsequently handwriting trace as a continuation of a previously handwriting trace in accordance with an instruction provided from the presenter. Consequently, the presenter can add information to meeting material with his or her timing without concern for the display end time of a handwriting trace.

Besides, the PC 10 according to Embodiment 1 is capable of always displaying (permanently displaying) a handwriting trace on meeting material in accordance with an instruction provided from the presenter. Hence, when the presenter wishes to make reference to handwritten information in an explanation given afterward, the presenter sets permanent display for a handwriting trace, thereby allowing the handwriting trace to be used also in the explanation given afterward. In addition, the PC 10 according to Embodiment 1 is capable of erasing even the trace, for which permanent display is set, from the display screen in accordance with an instruction provided from the presenter. Consequently, the presenter can write information without concern for degradation in viewability of meeting material, which is caused by handwriting performed on the meeting material that is being displayed.

The PC 10 according to Embodiment 1 is configured so that coordinate values of respective points indicative of a handwriting trace are stored in the trace table 2a at the trace accumulation time intervals (e.g., at intervals of one millisecond). In addition, for example, whether or not a handwriting trace is a straight line is determined, and upon determination that the handwriting trace is a straight line, only coordinate values of a start position of the handwriting straight line and coordinate values of an end position thereof may be stored in the trace table 2a. Further, a mode of inputting a straight line may be prepared, a trace handwriting after this mode has been set may be determined as a straight line, and only coordinate values of a start position of the handwriting trace and coordinate values of an end position thereof may be stored in the trace table 2a. Note that a trace determined as a straight line and is other traces may be stored in different tables, or a trace determined as a straight line and other traces may be stored in the same table by providing a flag indicative of a start position or end position of the straight line in the trace table 2a. Furthermore, when a trace determined as a straight line is stored in a table, coordinate values of a start position of each trace (straight line) and coordinate values of an end position thereof may be sequentially stored, or coordinate values of a start position of each trace and coordinate values of an end position thereof may be sequentially stored as one piece of data for each trace.

The PC 10 according to Embodiment 1 is configured so that when a newly inputted trace coincides with part of a trace that is being displayed or part of a saved trace that is being displayed, a corresponding menu image is displayed to receive selection of a process that should be executed. In addition, a preset operation may be performed in accordance with each process; for example, part of a trace or saved trace, which is being displayed, may be subjected to an operation for a predetermined period of time or longer (pressed and held) or may be subjected to an operation performed a predetermined number of times (pressed twice) via the operation section 3a, thereby selecting a process that should be executed. Thus, an instruction for executing an optional process is allowed without having to display a menu image, thereby enabling a further reduction in the operation load of the presenter.

The PC 10 according to Embodiment 1 is configured so that upon start of a series of handwriting inputs, it is determined whether or not coordinate values corresponding to the time 0 min 00 sec 00 msec, indicated by the trace accumulation timer, coincide with part of trace information stored in the trace table 2a or the saved trace table 2b, and a process corresponding to a determination result is performed. However, in addition to coordinate values corresponding to the time 0 min 00 sec 00 msec, the PC 10 according to Embodiment 1 may determine whether or not any coordinate values corresponding to a predetermined time that has elapsed from 0 min 00 sec 00 msec coincide with part of trace information stored in the trace table 2a or the saved trace table 2b. In that case, even if a start of handwriting does not coincide with part of a trace or saved trace that is being displayed, the presenter's desire to perform a process on the trace or saved trace that is being displayed can be grasped when a trace written within a predetermined time since the start of handwriting coincides with part of the trace or saved trace that is being displayed. Hence, the presenter does not have to strictly start handwriting on a trace or saved trace that is being displayed, thereby enabling a reduction in the operation load of the presenter.

### Embodiment 2

Hereinafter, a PC according to Embodiment 2 will be described. Note that the PC according to Embodiment 2 may be implemented by the same configuration as that of the PC 10 according to Embodiment 1 described above, and therefore, the is description of the configuration of the PC according to Embodiment 2 will be omitted.

The PC 10 according to Embodiment 2 performs the same processes as those performed by the PC 10 according to Embodiment 1 described above. Specifically, the PC 10 according to Embodiment 2 allows meeting material data, stored in the storage section 2, to be displayed on the display section 4a in accordance with an instruction provided from a presenter who makes a presentation using the PC 10, and allows information, inputted by handwriting by the presenter via the operation section 3a, to be displayed so as to be superimposed on meeting material that is being displayed.

Note that when information inputted by handwriting by the presenter via the operation section 3a is displayed so as to be superimposed on meeting material that is being displayed, the PC 10 according to Embodiment 2 performs processing for displaying the information with a display color different for each information inputted by handwriting. Specifically, the trace display section (display color setting section) 19 decides a single display color, plots a point, indicated by respective coordinate values stored in the trace table 2a, using the decided display color, and adds a straight line with the decided display color between this point and the immediately preceding plotted point as long as the immediately preceding coordinate values are not (−1, −1). On the other hand, when the immediately preceding coordinate values are (−1, −1), the trace display section 19 decides a different display color, and continues to plot a point indicated by respective coordinate values and to add a straight line between the points using the decided display color until the coordinate values become (−1, −1).

Similarly, the trace display section 19 further decides a different display color, plots a point, indicated by respective coordinate values stored in the saved trace table 2b, using the decided display color, and adds a straight line with the decided display color between this point and the immediately preceding plotted point as long as the immediately preceding coordinate values are not (−1, −1). On the other hand, when the immediately preceding coordinate values are (−1, −1), the trace display section 19 further decides a different display color, and continues to plot a point indicated by respective coordinate values and to add a straight line between the points using the decided display color until the coordinate values become (−1, −1).

Thus, trace information for allowing the trace and saved trace, handwritten by the presenter and stored in the trace table 2a and the saved trace table 2b, respectively, to be displayed with a different display color for each trace can be generated.

Note that a display color to be set for each trace may be allocated to each trace in a predetermined order in advance, or may be freely allocated from an unused one.

Hereinafter, processing performed by the control section 1 when a handwriting input is made via the operation section 3a in the PC 10 according to Embodiment 2 will be mentioned. The processing performed by the control section 1 in the PC 10 according to Embodiment 2 is the same as that described with reference to FIGS. 5 and 6 in Embodiment 1, and therefore, the description thereof will be omitted.

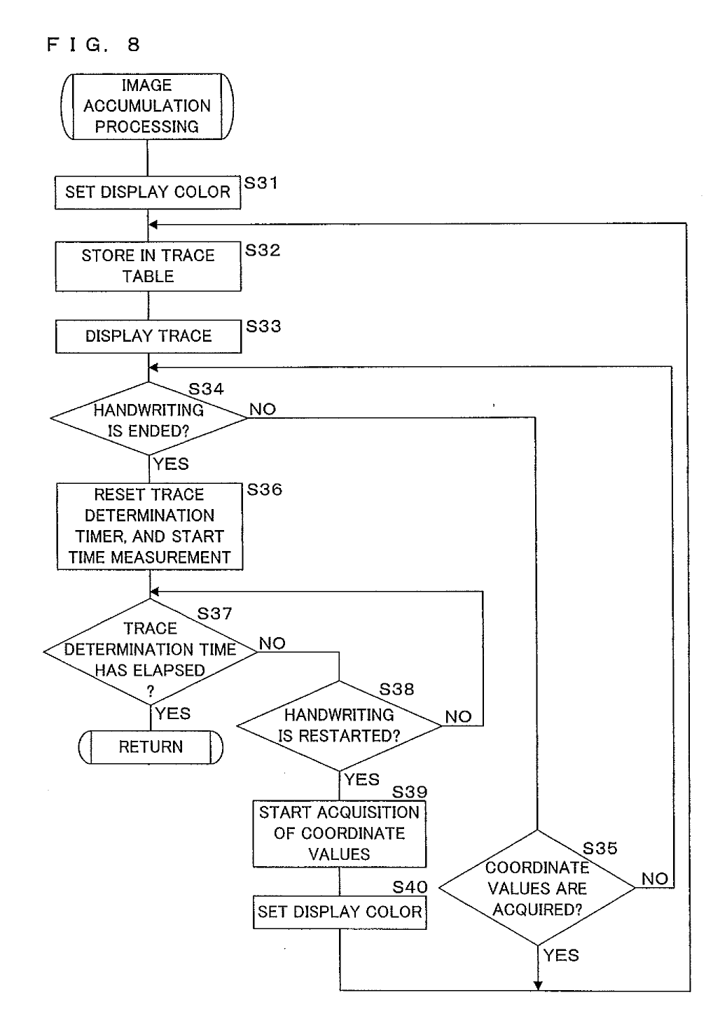

Next, trace accumulation processing (corresponding to Step S8 in FIG. 6) performed by the control section 1 in the PC 10 according to Embodiment 2 will be described with reference to a flow chart. FIG. 8 is a flow chart illustrating a procedure of the trace accumulation processing.

When a handwriting input is started, the control section 1 sets a display color for one trace whose trace information will be stored in the trace table 2a (S31). The control section 1 allocates a number to: the time indicated by the trace accumulation timer sequentially updated by the time measurement process started in Step S2 in FIG. 5; and the coordinate values (coordinate values of a trace point) sequentially acquired by the acquisition process started in Step S3, and allows the resulting information to be stored in the trace table 2a (S32). Using the display color set in Step S31, the control section 1 allows the trace, indicated by the trace information (coordinate values) stored in the trace table 2a, to be displayed on meeting material that is being displayed on the display section 4a (S33).

The control section 1 determines whether or not the handwriting input by the presenter is ended (S34). Upon determination that the handwriting input is not ended (S34: NO), the control section 1 determines whether or not coordinate values, obtained at the predetermined time intervals (at the trace accumulation time intervals), are acquired (S35). Then, upon determination that subsequent coordinate values are not acquired (S35: NO), the control section 1 returns the procedure to Step S34, and repeats the processes of Steps S34 and S35 until the handwriting input is ended by the presenter or the subsequent coordinate values are acquired.

Upon determination that the subsequent coordinate values are acquired (S35: YES), the control section 1 returns the procedure to Step S32, allocates a number to the time indicated by the trace accumulation timer and the subsequently acquired coordinate values, and allows the resulting information to be stored in the trace table 2a (S32). Then, the control section 1 repeats the process of Step S33 and the subsequent processes. Upon determination that the handwriting input by the presenter is ended (S34: YES), the control section 1 resets the trace determination timer to 0 min 00 sec 00 msec, and starts measurement of the preset trace determination time (S36).

The control section 1 determines whether or not the trace determination time has elapsed based on the time indicated by the trace determination timer (S37), and upon determination that the trace determination time has elapsed (S37: YES), the procedure is returned to that illustrated in FIGS. 5 and 6. On the other hand, upon determination that the trace determination time has not elapsed (S37: NO), the control section 1 determines whether or not the handwriting input by the presenter is restarted based on the information acquired from the input processing section 3 (S38). Upon determination that the handwriting input is not restarted (S38: NO), the control section 1 returns the procedure to Step S37, and repeats the processes of Steps S37 and S38 until the trace determination time elapses or the handwriting input is restarted.

Upon determination that the handwriting input by the presenter is restarted (S38: YES), the control section 1 starts acquisition of coordinate values of respective points indicative of a trace, handwritten by the presenter, based on the information acquired from the input processing section 3 (S39). Then, the control section 1 sets an unused display color for one trace whose trace information will be stored in the trace table 2a (S40). The control section 1 returns the procedure to Step S32, allocates a number to the time indicated by the trace accumulation timer and the acquired coordinate values, and allows the resulting information to be stored in the trace table 2a (S32). Thereafter, the control section 1 repeats the process of Step S33 and the subsequent processes. Note that in this case, using the display color set in Step S40, the control section 1 allows the trace, indicated by the trace information (coordinate values) stored in the trace table 2a, to be displayed on the meeting material that is being displayed on the display section 4a (S33).

As a result of the above-described processing, the PC 10 according to Embodiment 2 is capable of allowing a trace, handwritten by the presenter, to be displayed with a different color for each trace. Hence, for example, when a mark, such as an underline, a box or a sign, is handwritten at a position on meeting material that is being displayed, such as a position to which attention is desired to be given by listeners or a position on which an explanation will be given from now, each mark can be displayed with a different color. Accordingly, during a presentation, the presenter can prompt the listeners to give attention to any position, e.g., a “position with a red line”, in the meeting material by using the display color of each trace, and thus can make an efficient presentation. In particular, even when a plurality of analogous traces are intermingled on the display screen, visibility is increased by displaying each trace with a different display color, thereby facilitating determination of each trace.

The PC 10 according to Embodiment 2 is configured so that information inputted by handwriting by the presenter via the operation section 3a is displayed so as to be superimposed on meeting material, which is being displayed, with a different display color for each information inputted by handwriting. In addition, for example, information inputted by handwriting by the presenter via the operation section 3a may be displayed with a line different in type or thickness for each information inputted by handwriting. In that case, in Steps S31 and S40 in the trace accumulation processing illustrated in FIG. 8, the control section 1 may set a line type or thickness when a trace for information inputted by handwriting is displayed instead of setting a display color. Thus, during a presentation, the presenter uses a line different in type or thickness for each trace, such as a “position with a wavy line”, a “position surrounded by a broken line” or a “position with a thick line”, for example, thereby facilitating determination of each trace and enabling an efficient presentation.

### Embodiment 3

Hereinafter, a PC according to Embodiment 3 will be described. Note that the PC according to Embodiment 3 may be implemented by the same configuration as that of the PC 10 according to Embodiment 1 described above, and therefore, the description of the configuration of the PC according to Embodiment 3 will be omitted.

The PC 10 according to Embodiment 3 performs the same processes as those performed by the PC 10 according to Embodiment 1 described above. Specifically, the PC 10 according to Embodiment 3 allows meeting material data, stored in the storage section 2, to be displayed on the display section 4a in accordance with an instruction provided from a presenter who makes a presentation using the PC 10, and allows information, inputted by handwriting by the presenter via the operation section 3a, to be displayed so as to be superimposed on meeting material that is being displayed.

Note that when information, inputted by handwriting by the presenter via the operation section 3a, is displayed so as to be superimposed on meeting material that is being displayed, the PC 10 according to Embodiment 3 performs processing for changing a display color with the passage of time. Specifically, the order of display of a plurality of display colors is set in advance, and the trace display section (display color setting section) 19 decides a different display color every time a predetermined time (color change time) elapses and outputs, to the display section 4a, trace information for displaying a trace, whose trace information is stored in the trace table 2a, using the decided color. Thus, the trace display section 19 is capable of displaying the trace, handwritten by the presenter, using a different display color every time the predetermined time elapses.

Hereinafter, processing performed by the control section 1 when a handwriting input is made via the operation section 3a in the PC 10 according to Embodiment 3 will be described. Note that the control section 1 according to Embodiment 3 performs the following processing when a handwriting trace is displayed on the display section 4a while performing the processing described with reference to FIGS. 5 to 7 in Embodiment 1.

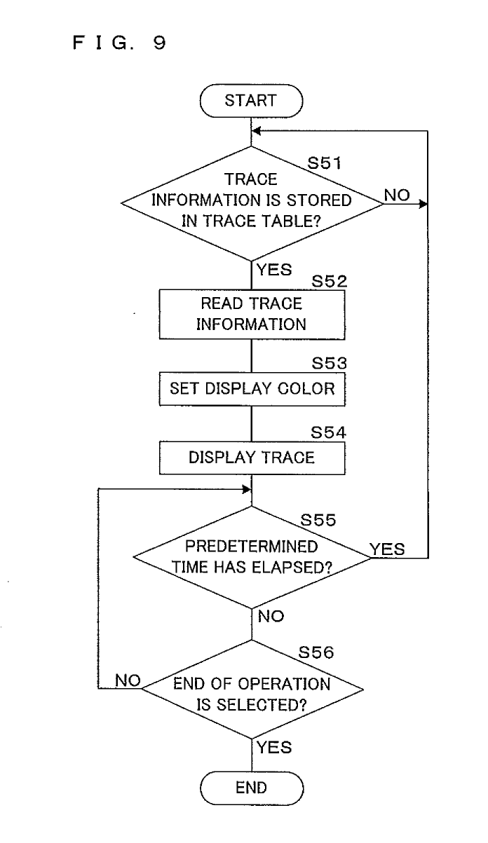

FIG. 9 is a flow chart illustrating a procedure of the processing performed by the control section 1 when a trace is displayed. The following processing is executed by the control section 1 in accordance with the control program stored in the storage section 2 of the PC 10.

The control section 1 of the PC 10 determines whether or not trace information is stored in the trace table 2a (S51), and upon determination that no trace information is stored (S51: NO), the control section 1 enters a standby mode while performing the processing illustrated in FIGS. 5 to 7. Upon determination that trace information is stored in the trace table 2a (S51: YES), the control section 1 reads the trace information (coordinate values) stored in the trace table 2a (S52), and sets a display color for a trace that is based on the read trace information (S53).

The control section 1 outputs, to the display section 4a, the trace information (coordinate values) for displaying the trace, which is based on the read trace information, using the set display color, thereby allowing the trace, which is based on the trace information, to be displayed (S54). The control section 1 determines whether or not the predetermined time (color change time) has elapsed since the display of the trace on the display section 4a (S55), and upon determination that the predetermined time has not elapsed (S55: NO), the control section 1 determines whether or not the end of operation of the PC 10 is selected (S56). Upon determination that the end of operation of the PC 10 is not selected (S56: NO), the control section 1 returns the procedure to Step S55, and repeats the processes of Steps S55 and S56 until the predetermined time elapses or the end of operation of the PC 10 is selected.

Upon determination that the predetermined time has elapsed (S55: YES), the control section 1 returns the procedure to Step S51, and repeats the foregoing processes. Thus, the trace, which is based on the trace information stored in the trace table 2a, is displayed with a different display color every time the predetermined time elapses. Upon determination that the end of operation of the PC 10 is selected (S56: YES), the control section 1 ends the operation of the PC 10.

As a result of the above-described processing, the PC 10 according to Embodiment 3 is capable of displaying a trace, handwritten by the presenter, using a different display color every time the predetermined time elapses. Hence, a position to which attention is desired to be given by listeners can be further highlighted, and thus can attract more attention of listeners. In particular, when a trace is displayed by alternately using display colors having a large difference in lightness, the trace can be displayed so that the trace blinks (flashes), and a position to which attention is desired to be given by listeners can be more clearly presented. Further, for example, when a trace is displayed using a display color that is temporarily conspicuous immediately after being handwritten, the trace can be temporarily highlighted.

The PC 10 according to Embodiment 3 is configured so that information, inputted by handwriting by the presenter via the operation section 3a, is displayed so as to be superimposed on meeting material, which is being displayed, by using a different display color every time the predetermined time elapses. In addition, for example, information inputted by handwriting by the presenter via the operation section 3a may be displayed so that the density of a display color of the information is changed continuously or gradually with the passage of time, thereby obtaining similar effects. In that case, in Step S53 of the processing illustrated in FIG. 9, the control section 1 may set the density of a display color instead of setting a display color.

The PC 10 according to Embodiment 3 is configured so that a display color of a trace whose trace information is stored in the trace table 2a is changed with the passage of time. Similarly, a display color of a saved trace whose trace information is stored in the saved trace table 2b may be changed with the passage of time.

### Embodiment 4

Hereinafter, a PC according to Embodiment 4 will be described. Note that the PC according to Embodiment 4 may be implemented by the same configuration as that of the PC 10 according to Embodiment 1 described above, and therefore, the description of the configuration of the PC according to Embodiment 4 will be omitted.

The PC 10 according to Embodiment 4 performs the same processes as those performed by the PC 10 according to Embodiment 1 described above. Specifically, the PC 10 according to Embodiment 4 allows meeting material data, stored in the storage section 2, to be displayed on the display section 4a in accordance with an instruction provided from a presenter who makes a is presentation using the PC 10, and allows information, inputted by handwriting by the presenter via the operation section 3a, to be displayed so as to be superimposed on meeting material that is being displayed.

Note that in each of the PCs 10 according to Embodiments 1 to 3 described above, meeting material data displayed on the display section 4a, trace information stored in the trace table 2a, and trace information stored in the saved trace table 2b are handled as different layers. Specifically, when the trace table 2a is updated, only the layer of the trace information stored in the trace table 2a is updated and redisplayed on the display section 4a, and when the saved trace table 2b is updated, only the layer of the trace information stored in the saved trace table 2b is updated and redisplayed on the display section 4a.

In the PC 10 according to Embodiment 4, when the trace table 2a or the saved trace table 2b is updated, display of all pieces of data on the display section 4a is temporarily ended, and then meeting material data, trace information stored in the trace table 2a and trace information stored in the saved trace table 2b are displayed again.

Hereinafter, processing performed by the control section 1 when the trace table 2a or the saved trace table 2b is updated in the PC 10 according to Embodiment 4 will be described. Note that the control section 1 according to Embodiment 4 performs the following processing when the trace table 2a or the saved trace table 2b is is updated while performing the processing described with reference to FIGS. 5 to 7 in Embodiment 1.

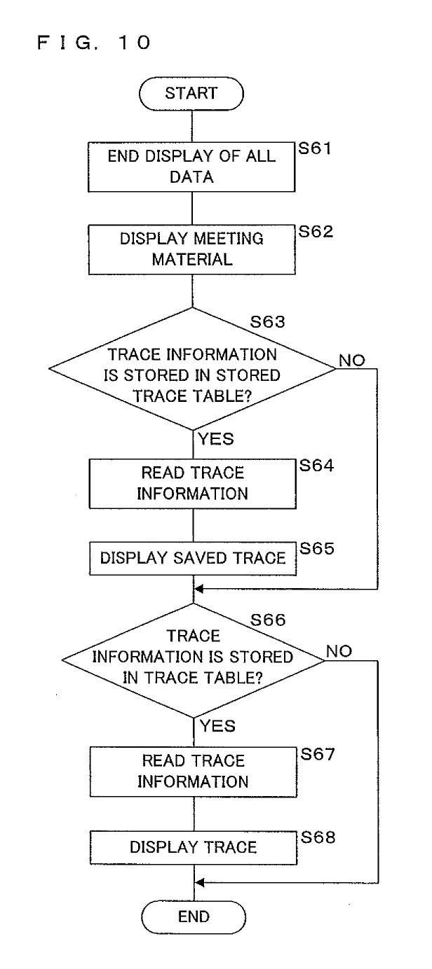

FIG. 10 is a flow chart illustrating a procedure of the processing performed by the control section 1 when the trace table 2a or the saved trace table 2b is updated. The following processing is executed by the control section 1 in accordance with the control program stored in the storage section 2 of the PC 10.

Upon updating of the trace table 2a or the saved trace table 2b, the control section 1 of the PC 10 stops outputting, to the display section 4a, meeting material data that is being displayed on the display section 4a and trace information stored in the trace table 2a and the saved trace table 2b, thereby ending the display of these pieces of data on the display section 4a (S61). Then, the control section 1 outputs, to the display section 4a, meeting material data that should be displayed on the display section 4a, thereby allowing meeting material to be displayed thereon (S62).

The control section 1 determines whether or not trace information is stored in the saved trace table 2b (S63), and upon determination that no trace information is stored in the saved trace table 2b (S63: NO), the control section 1 moves the procedure to Step S66. Upon determination that trace information is stored in the saved trace table 2b (S63: YES), the control section 1 reads the trace information stored in the saved trace table 2b (S64), outputs the read trace information to the display section 4a, and allows a saved trace, which is based on the trace information, to be displayed on the meeting material that is being displayed (S65).

The control section 1 determines whether or not trace information is stored in the trace table 2a (S66), and upon determination that no trace information is stored in the trace table 2a (S66: NO), the control section 1 ends the foregoing processing. Upon determination that trace information is stored in the trace table 2a (S66: YES), the control section 1 reads the trace information stored in the trace table 2a (S67), outputs the read trace information to the display section 4a, and allows a trace, which is based on the trace information, to be displayed on the meeting material that is being displayed (S68). Thus, the meeting material, the trace that is based on the trace information stored in the trace table 2a, and the saved trace that is based on the trace information stored in the saved trace table 2b are redisplayed, and the control section 1 ends the foregoing processing.

As a result of the above-described processing, when the trace table 2a or the saved trace table 2b is updated, the PC 10 according to Embodiment 4 allows redisplay of meeting material that should be displayed on the display section 4a, and trace and saved trace that have already been handwritten, thereby preventing occurrence of omission of display. Further, display of unnecessary trace and saved trace can be ended with reliability.

The PC 10 according to Embodiment 4 is configured so that when the trace table 2a or the saved trace table 2b is updated, meeting material data, and trace information stored in the trace table 2a and the saved trace table 2b are redisplayed. In addition, also when meeting material data that should be displayed on the display section 4a is updated, similar processing may be performed.

In each of Embodiments 1 to 4 described above, the description has been made on an example in which the input-output apparatus according to the present invention is applied to the PC 10. However, in addition to the PC 10, the input-output apparatus according to the present invention may also be applicable to an input apparatus such as a touch panel to be connected to a device such as a personal computer or a server computer. Furthermore, the input-output apparatus according to the present invention may also be applicable to a terminal apparatus used in a meeting system configured so that a plurality of terminal apparatuses (personal computers) are connected to an IP network. In that case, in addition to meeting material, information added on the meeting material by handwriting can be shown to not only listeners in the same room but also participants who participate in a meeting via the IP network.

Note that the embodiments disclosed herein are illustrative in all respects, and should not be considered as restrictive. The scope of the present invention is defined by the claims rather than by the preceding description, and all changes within the meaning and range of equivalency of the claims are intended to be embraced therein.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An input-output apparatus comprising:
a data output section for outputting data to a display device to display the data thereon;
a trace receiving section for receiving a handwriting trace;
a trace output section for outputting the trace, received by the trace receiving section, to the display device to display the trace on the data displayed on the display device; and
a time measurement section for measuring, upon reception of a trace by the trace receiving section, time elapsed until a subsequent trace is received,
wherein upon reception of the subsequent trace by the trace receiving section after a predetermined time has been measured by the time measurement section, the trace output section ends output of the previously received trace to the display device.

2. The input-output apparatus according to claim 1, further comprising:
a determining section for determining, upon reception of a trace by the trace receiving section, whether or not the received trace coincides with part of the trace that has previously been received by the trace receiving section and that is being displayed on the display device;
a menu output section for outputting, upon determination by the determining section that the received trace coincides with part of the trace that is being displayed, a menu image to the display device to display the menu image thereon, the menu image being outputted for selection of a process to be performed on the trace that is being displayed;
a selection receiving section for receiving selection of the process; and
an execution section for executing the process, the selection of which has been received by the selection receiving section.

3. The input-output apparatus according to claim 2,
wherein the process comprises a continuation process for continuing handwriting on the trace that is being displayed, and
wherein upon reception of selection of the continuation process by the selection receiving section, the execution section allows the trace receiving section to receive, as a continuation of the trace that is being displayed, a trace that is subsequently handwritten.

4. The input-output apparatus according to claim 2,
wherein the process comprises a saving process for saving the trace that is being displayed,
wherein the execution section has a storage processing section for storing the trace, which is being displayed, in a storage section upon reception of selection of the saving process by the selection receiving section, and
wherein the trace output section outputs, to the display device, the trace stored in the storage section.

5. The input-output apparatus according to claim 4, further comprising:
a judging section for judging whether or not the trace that is being displayed is stored in the storage section upon determination by the determining section that the received trace coincides with part of the trace that is being displayed;
an instruction receiving section for receiving an instruction for making a decision on whether the trace should be erased from the storage section upon judgment by the judging section that the trace is stored in the storage section; and
an erasing section for erasing the trace from the storage section upon reception of an erasure instruction by the instruction receiving section.

6. The input-output apparatus according to claim 1, further comprising a display color setting section for setting a display color different for each trace displayed on the display device,
wherein the trace output section outputs, to the display device, a trace for which a display color is set by the display color setting section.

7. The input-output apparatus according to claim 1, further comprising a display color setting section for changing, with passage of time, a display color of a trace displayed on the display device,
wherein the trace output section outputs, to the display device, a trace for which a display color is set by the display color setting section.

8. The input-output apparatus according to claim 1, further comprising a display color setting section for changing, with passage of time, a density of a display color of a trace displayed on the display device,
wherein the trace output section outputs, to the display device, a trace for which a display color is set by the display color setting section.

9. The input-output apparatus according to claim 1, further comprising a display line setting section for setting a line type different for each trace displayed on the display device,
wherein the trace output section outputs, to the display device, a trace for which a line type is set by the display line setting section.

10. An input-output method for outputting data to a display device to display the data thereon, receiving a handwriting trace, and outputting the received trace to the display device to display the trace on the data displayed on the display device, the method comprising steps of:
measuring, upon reception of a trace, time elapsed until a subsequent trace is received; and
ending output of the previously received trace to the display device upon reception of the subsequent trace after a predetermined time has been measured.

11. A non-transitory recording medium recording a computer program for allowing a computer to: output data to a display device to display the data thereon; receive a handwriting trace; and output the received trace to the display device to display the trace on the data displayed on the display device, said computer program comprising steps of:
allowing the computer to measure, upon reception of a trace, time elapsed until a subsequent trace is received; and
allowing the computer to end output of the previously received trace to the display device upon reception of the subsequent trace after a predetermined time has been measured.
